(19) United States
(12) Patent Application Publication
(10) Pub. No.: US 2008/0175132 A1
(43) Pub. Date: Jul. 24, 2008

(54) GAIN CONTROL SYSTEM AND CALIBRATION METHOD THEREOF

(75) Inventors: Chia-Hua Chou, Taipei County (TW); Tse-Hsiang Hsu, Hsin-chu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/624,719

(22) Filed: Jan. 19, 2007

(51) Int. Cl. G11B 7/00

(52) U.S. Cl. 369/124.1

(57) ABSTRACT

A gain control system for compact disc laser reader is provided, comprising two AGCs, comparator and a calibration unit. The first AGC receives a calibration signal to generate a first output signal with a first gain. The second AGC receives the calibration signal to generate a second output signal with a second gain. The comparator is coupled to the first and second AGCs, comparing the first output signal and the second output signal to generate a differential signal. The calibration unit, coupled to the comparator, adjusts the first control voltage or the second control voltage based on the differential signal, such that the amplitudes of the first output signal and the second output signal are compensated identically.

### BACKGROUND

The invention relates to AGC, and in particular, to a calibration method for a gain control system in optical laser disc devices.

FIG. 1 shows a conventional auto gain controller (AGC) 100. With a various gain amplifier (VGA) 102, an input voltage Vᵢₙ is amplified to an output voltage Vₒᵤₜ having amplitude associated with a reference voltage V_{ref}. An amplitude detector 104 is coupled to the VGA 102, detecting the amplitude of the output voltage Vₒᵤₜ to generate a feedback signal V_{back}. A comparator 106 generates a differential signal V_{diff} by comparing the reference voltage V_{ref} and the feedback signal V_{back}, and the differential signal V_{diff} is integrated in the integrator 108 to generate a control voltage V_{ctrl} which is then fed back to control the amplification in the VGA 102, thus, the amplitude of output voltage Vₒᵤₜ can be controlled.

### SUMMARY

An exemplary embodiment of a gain control system for compact disc laser reader is provided, comprising two AGCs, comparator and a calibration unit. The first AGC receives a calibration signal to generate a first output signal with a first gain. The second AGC receives the calibration signal to generate a second output signal with a second gain. The comparator is coupled to the first and second AGCs, comparing the first output signal and the second output signal to generate a differential signal. The calibration unit, coupled to the comparator, adjusts the first control voltage or the second control voltage based on the differential signal, such that the amplitudes of the first output signal and the second output signal are compensated identically.

Another embodiment of the gain control system comprises three AGCs. The third AGC is coupled to the comparator, amplifying the differential signal based on a predetermined voltage, and detecting the amplitude of the differential signal to generate a feedback signal. The calibration unit is coupled to the third AGC, adjusting the first and second control voltages based on the feedback signal, such that the amplitudes of the first and second output voltages are equalized.

A further embodiment of a calibration method for a gain control system comprising a first and a second AGC is provided. First and second control voltages are generated and sent to the first and second AGCs. A calibration signal is amplified by the first AGC to generate a first output voltage by reference of the first control voltage. The calibration signal is amplified by the second AGC to generate a second output voltage by reference to the second control voltage. The first and second output voltages are compared to generate a differential signal. The first control voltage or second control voltage are adjusted based on the differential signal, such that the amplitudes of the first output voltage and second output voltage are equalized.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 shows a conventional AGC;

FIG. 2 shows a gain control system;

FIG. 3 shows waveforms generated by a gain control system;

FIG. 4 shows an embodiment of a gain control system;

FIG. 5 shows another embodiment of the gain control system;

FIG. 6 is a circuit diagram of the calibration unit 602 in FIG. 4;

FIG. 7 is a circuit diagram of the calibration unit 602 in FIG. 5; and

FIG. 8 is a flowchart of the calibration method.

### DETAILED DESCRIPTION

A detailed description of the present invention is provided in the following.

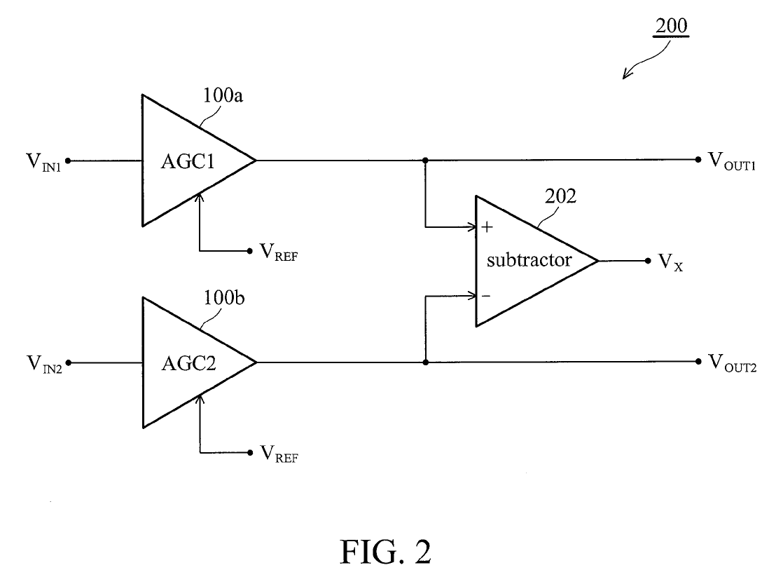

FIG. 2 shows an exemplary control system. The gain control system 200 is typically employed in a laser reader of a compact disc system. Data stored in the track is read by reflection of laser beams, and four laser readers are simultaneously utilized to read a specific track. A first input signal Vᵢₙ₁ and a second input signal Vᵢₙ₂, presenting as data, are detected by two of the laser readers, comprising waveforms of:

Vᵢₙ₁=A₁(D+sin 2πωt)

Vᵢₙ₂=A₂(D−sin 2πωt)

where D is the data stream having a high frequency of 70 MHz, the first gain A₁ and second gain A₂ are amplitudes of the first input signal Vᵢₙ₁ and second input signal Vᵢₙ₂, and sin 2πωt is a low frequency track signal (Vₓ) of 10 MHz. Thus, the gain control system 200 receives the first input signal Vᵢₙ₁ and Vᵢₙ₂, adjusts the first gain A₁ and second gain A₂ to generate the first and second output voltages, and obtains the low frequency track signal Vₓ by comparing the first input signal Vᵢₙ₁, and second input signal Vᵢₙ₂. Two identical AGCs 100a and 100b are provided to transform the first and second input signals Vᵢₙ₁/Vᵢₙ₂ with reference of a common reference voltage V_{ref}, however, the AGCs 100a and 100b may not be perfectly matched, and errors therebetween occur.

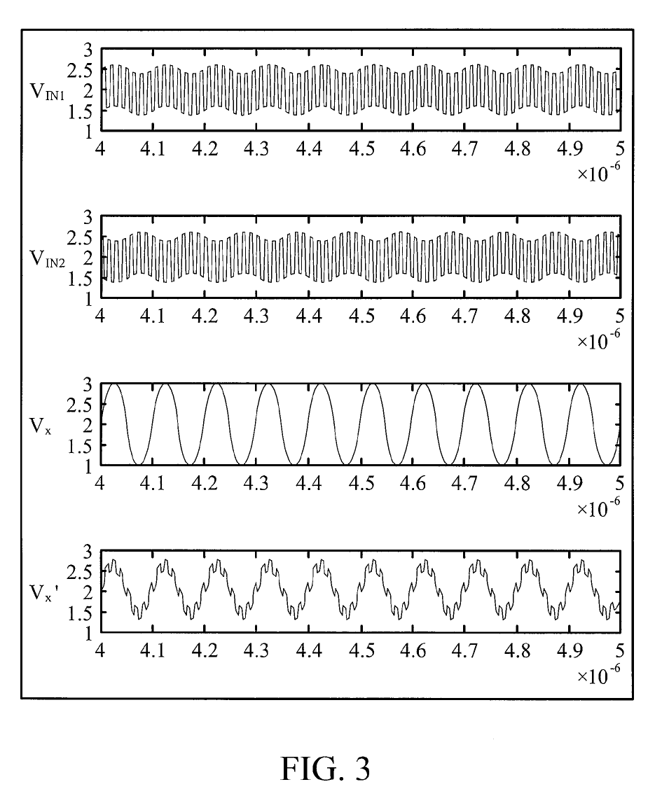

FIG. 3 shows various waveforms driven by the gain control system 200. As described, Vᵢₙ₁ and Vᵢₙ₂ are waveforms comprising high and low frequency components. Ideally, the amplitudes of the first output voltage Vₒᵤₜ₁ and second output voltage Vₒᵤₜ₂ are adjusted to identical values, such that the subtraction generates a perfect sinusoidal wave, Vₓ. In practical application, however, circuit mismatch and various erroneous conditions occur, and the two AGCs 100a and 100b may perform differently under identical circumstance, inducing different amplitudes of the first and second output voltages, and generating a distorted signal Vₓ′.

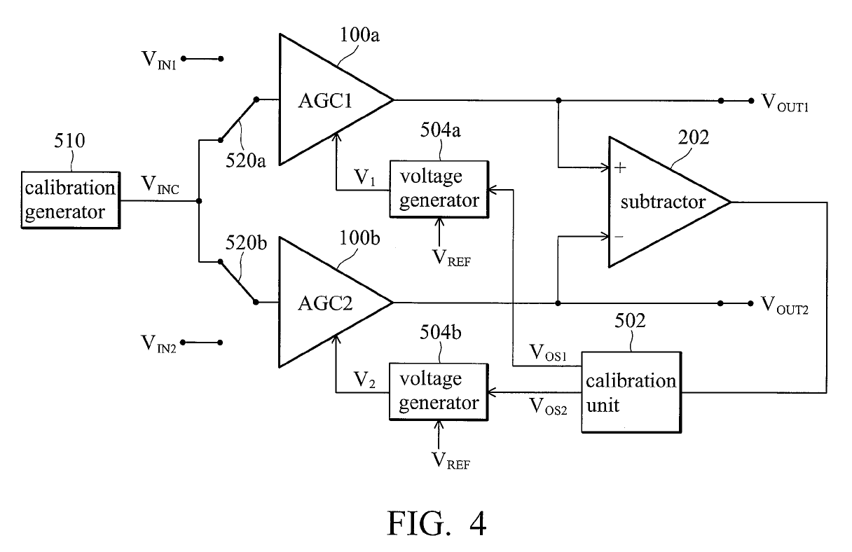

FIG. 4 shows an embodiment of a gain control system. pair of AGCs 100a and 100b and subtractor 202 are conventional components. A calibration unit 502 is further provided in the embodiment, coupled to the output of subtractor 202 to detect the differential signal Vₛ, and accordingly adjusting the first control voltage V₁ and second control voltage V₂ sent to the AGCs 100a and 100b. Initially, the gain control system operates in a calibration mode. A calibration generator 510 commonly coupled to the first and second AGCs 100, provides a calibration voltage V_{INC} thereto. The first and second switches 520a and 520b respectively connect the calibration generator 510 to the first and second AGCs 100a and 100b. The first and second AGCs 100a and 100b may have different amplification results even based on the same reference voltage V_{ref}, thus a first and a second voltage generators 504a and 504b are provided to generate a first control voltage V₁ and a second control voltage V₂ that are adjusted to compensate the difference. The calibration unit 502 generates the first adjustment signal Vₒₛ₁ and second adjustment signal Vₒₛ₂ that are respectively added to the reference voltages V_{ref} in the voltage generators 504a and 504b, thus the corresponding first control voltage V₁ and second control voltage V₂ are generated. The subtractor 202 compares the first output voltage Vₒᵤₜ₁ and the second output voltage Vₒᵤₜ₂ output from the first and second AGCs 100a and 100b and feeds back a differential signal Vₛ to the calibration unit 502, forming a feedback loop. The calibration unit 502 may perform a plurality of test loops to determine a best mode. For example, 64 calibration loops may be performed. In the calibration loops, the first adjustment signal Vₒₛ₁ may be fixed at a predetermined level, and the second adjustment signal Vₒₛ₂ may have a variation of 64 voltage levels. As a result, 64 differential signal Vₛ are fed back and stored in the calibration unit 502, among which a minimum value can be found as a best mode. For an ideal system, the minimum value of differential signal Vₛ is zero. When the first adjustment signal Vₒₛ₁ and the second adjustment signal Vₒₛ₂ of the best mode are determined, the gain control system operates in a normal mode, and the first and second input voltages Vᵢₙ₁/Vᵢₙ₂ are converted to a first output voltage Vₒᵤₜ₁ and a second output voltage Vₒᵤₜ₂ having equal amplitudes.

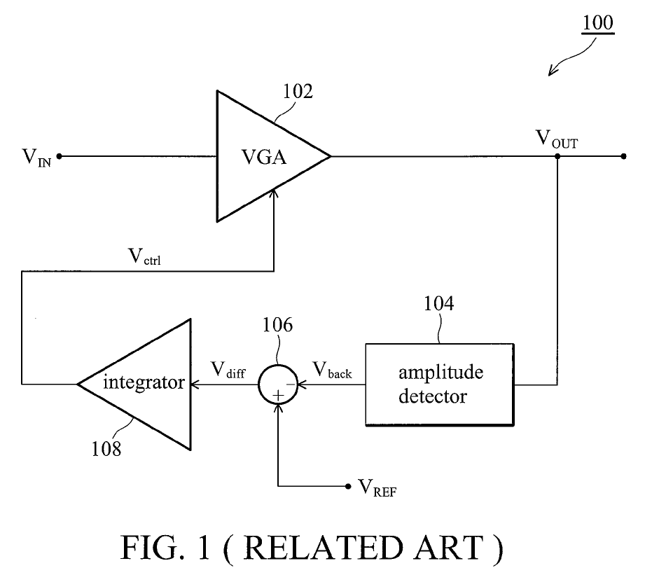

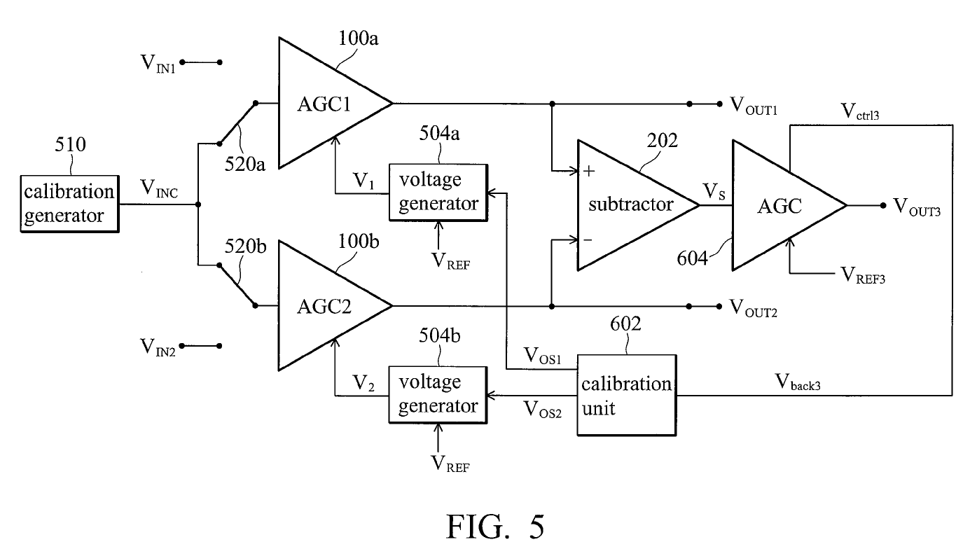

FIG. 5 shows another embodiment of the gain control system. A third AGC 604 is coupled to the subtractor 202, receiving the differential signal Vₛ. The third AGC 604 is similar to the AGC is FIG. 1, comprising a comparator 106 and an integrator 108. The comparator is 106 controlled by a third reference voltage V_{ref3} to amplify the differential signal Vₛ to an output voltage Vₒᵤₜ₃. The output of the integrator 108, control voltage V_{ctrl3}, is used as a feedback signal V_{back3} sent to the calibration unit 602. The level of feedback signal V_{back3} is inversely proportional to the differential signal Vₛ. Thus, when the first and second output voltages are perfectly matched, the feedback signal V_{back3} responses with an exceedingly high level. The calibration unit 602 receives the feedback signal V_{back3} to perform the calibration loop. Since the differential signal Vₛ is a distorted waveform due to amplitude mismatch of the first and second output voltages Vₒᵤₜ₁/Vₒᵤₜ₂, the calibration unit 602 is easier to implement by detecting the responsive feedback signal V_{ref3}.

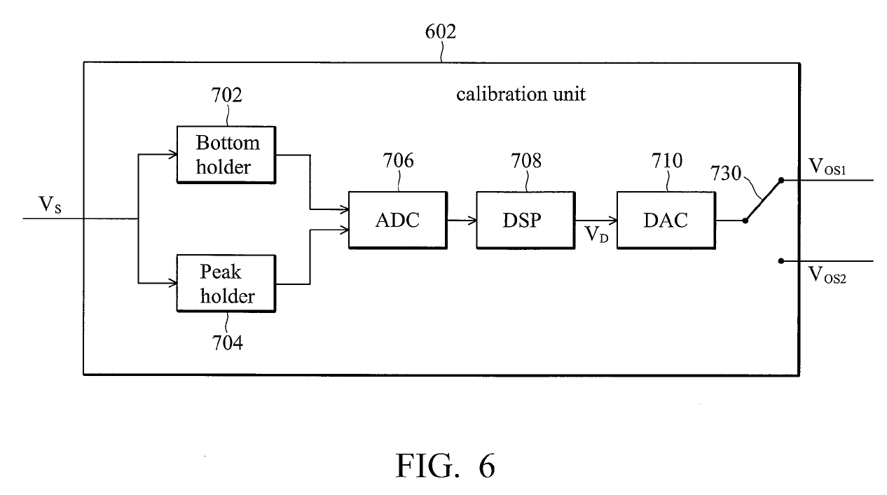

FIG. 6 is a circuit diagram of the calibration unit 602 in FIG. 5. The calibration unit 602 may perform a plurality of test loops to search an optimum combination of the first and second adjustment signal Vₒᵤₜ₁/Vₒᵤₜ₂ that compensates the AGC 100 mismatch. The digital signal processor (DSP) 708 recursively generates various digital values, and the digital to analog converter (DAC) 710 analogizes the digital values to the first or second adjustment signal Vₒₛ₂. The switch 730 selects the first AGC 100 or the second AGC 100 to perform the plurality of test loops. For example, if the switch 730 chooses the first AGC 100 to perform the test, the second AGC 100 is controlled by a fixed second control voltage V₂ (equal to reference voltage V_{ref}), and the first AGC 100 is controlled by a varying first control voltage V₁ (equal to reference voltage V_{ref} plus the first adjustment signal Vₒₛ₁). The digital values may comprise 6 bits with a variation of 64 levels, and the test loops are performed 64 times respectively. In response to the first control voltage V₁ and second control voltage V₂ delivered to the first and second AGCs 100a and 100b, the first and second output voltages Vₒᵤₜ₁ and Vₒᵤₜ₂ are generated and compared to generate the differential signal Vₛ. The bottom holder 702 and peak holder 704 detect the peak and bottom of the differential signal Vₛ, and the results are converted to digital values in the ADC 706 before storing in the DSP 708. When the DSP 708 completes 64 test loops, 64 corresponding results are obtained. Among the 64 results, an optimum result is found wherein the error between the first output voltage Vₒᵤₜ₁ and the second output voltage Vₒᵤₜ₂ is minimal (possibly zero). In this way, the optimum first adjustment signal Vₒₛ₁ is employed for normal operation of the gain control system.

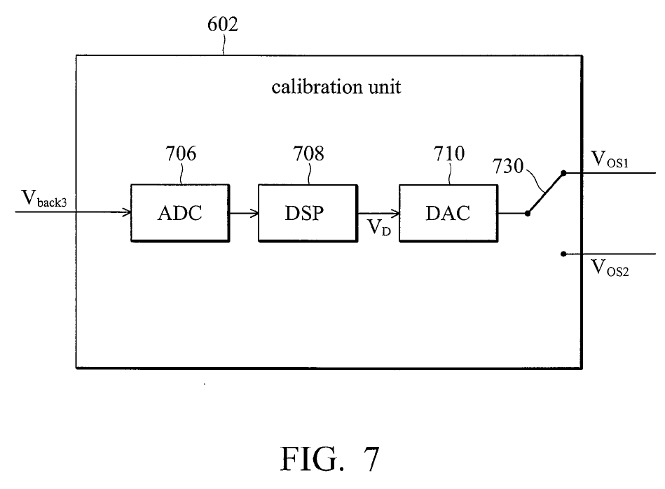

FIG. 7 is a circuit diagram of the calibration unit 602 in FIG. 5. The differential signal Vₛ may be a distorted waveform, thus the amplitude detection is implemented by a bottom holder 702 and a peak holder 704 in FIG. 6. In a situation as in FIG. 5, a third AGC 604 is provided to control the differential signal Vₛ gain and detect the amplitude thereof. A control voltage V_{ctrl} automatically controlling the VGA 102 in the third AGC 604 can be directly utilized as a feedback signal V_{back3}. In the calibration unit 602, the feedback signal V_{back3} is converted to digital values by the ADC 706, and the DSP 708, DAC 710 and switch 730 act identically as described in FIG. 6. The control voltage V_{ctrl} is inversely proportional to the error between the first and second output voltages Vₒᵤₜ₁ and Vₒᵤₜ₂. When the first and second output voltages Vₒᵤₜ₁ and Vₒᵤₜ₂ are identical, the control voltage V_{ctrl3} has the maximum level. Thus among the plurality of test loops performed by the DSP 708, a feedback signal V_{back3} having the maximum value is deemed to be the optimum result, and the corresponding control voltages Vₒₛ₁ and Vₒₛ₂ can be utilized for normal operation in the gain control system.

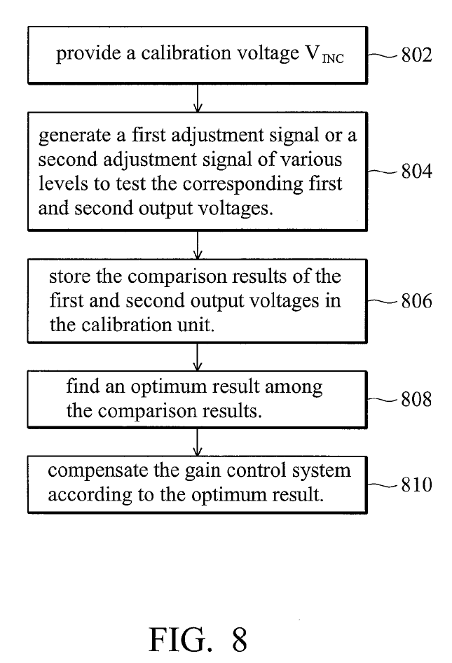

FIG. 8 is a flowchart of the calibration method. In step 802, a calibration voltage V_{INC} is provided to the first and second AGC 100. In step 804, the calibration unit 602 generates a first adjustment signal or a second adjustment signal of various levels to test the corresponding first and second output voltages. In step 806, the comparison results of the first and second output voltages are stored in the calibration unit. In step 808, an optimum result is found among the comparison results. For example, a differential signal Vₛ having the minimum amplitude, or a feedback signal V_{back3} having the maximum value, can be deemed to be the optimum result. In step 810, the gain control system is compensated accordingly to generate the first output voltage Vₒᵤₜ₁ and second output voltage Vₒᵤₜ₂ of identical magnitudes.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A gain control system for a compact disc laser reader, comprising:
a first AGC, receiving a calibration signal to generate a first output signal with a first gain, wherein the first gain is determined by a first control voltage;
a second AGC, receiving the calibration signal to generate a second output signal with a second gain, wherein the second gain is determined by a second control voltage;
a comparator, coupled to the first and second AGC, comparing the first output signal and the second output signal to generate a differential signal; and
a calibration unit, coupled to the comparator, adjusting the first control voltage or the second control voltage based on the differential signal, such that the amplitudes of the first output signal and the second output signal are compensated identical.

2. The gain control system as claimed in claim 1, further comprising:
a first switch, coupled to the first AGC, outputting a first input signal to the first AGC when in normal mode, and outputting the calibration signal to the first AGC when in calibration mode;
a second switch, coupled to the second AGC, outputting a second input signal to the second AGC when in normal mode, and outputting the calibration signal to the second AGC when in calibration mode; and
a calibration generator, coupled to the first and second switches, generating the calibration signal when in calibration mode; wherein
when in normal mode the first and second AGC amplify the first and second input signals respectively with the adjusted first and second gains to generate the first and second output signals.

3. The gain control system as claimed in claim 1, wherein the calibration unit generates a first adjustment signal and/or a second adjustment signal based on the differential signal, and the gain control system further comprises:
a first voltage generator, coupled to the calibration unit and the first AGC, receiving a reference voltage and the first adjustment signal to generate the first control voltage; and
a second voltage generator, coupled to the calibration unit and the second AGC, receiving the reference voltage and the second adjustment signal to generate the second control voltage.

4. The gain control system as claimed in claim 3, wherein the calibration unit comprises:
a DSP, generating an adjustment signal;
a DAC, coupled to the DSP, converting the adjustment signal to the first or second adjustment signal which is then sent to a corresponding voltage generator, and in response, the differential signal corresponding to the first and second output voltages are generated as an input signal;
a bottom holder, detecting a bottom level of the input signal;
a peak holder, detecting a peak level of the input signal; and
an ADC, coupled to the bottom holder, peak holder and DSP, converting the peak and bottom levels to a digital value; wherein:
the DSP recursively generates adjustment signals of various levels, and determines a best mode from the corresponding digital values so that the error between the first and second output voltages is minimal when operating in best mode.

5. A gain control system comprising:
a first AGC, receiving a calibration signal to generate a first output voltage with a first gain, wherein the first gain is determined by a first control voltage;
a second AGC, receiving the calibration signal to generate a second output voltage with a second gain, wherein the second gain is determined by a second control voltage;
a comparator, coupled to the first and second AGCs, comparing the first and second output voltages to generate a differential signal;
an third AGC, coupled to the comparator, amplifying the differential signal based on a predetermined voltage, and detecting the amplitude of the differential signal to generate a feedback signal; and
a calibration unit, coupled to the third AGC, adjusting the first and second control voltages based on the feedback signal, such that the amplitudes of the first and second output voltages are equalized.

6. The gain control system as claimed in claim 5, further comprising:
a first switch, coupled to the first AGC, outputting a first input signal to the first AGC when in a normal mode, and outputting the calibration signal to the first AGC when in a calibration mode;
a second switch, coupled to the second AGC, outputting a second input signal to the second AGC when in the normal mode, and outputting the calibration signal to the second AGC when in the calibration mode; and
a calibration generator, coupled to the first and second switches, generating the calibration signal when in the calibration mode; wherein
when in the normal mode:
the first and second AGCs respectively amplify the first and second input signals with the adjusted first and second gains to generate the first and second output voltages.

7. The gain control system as claimed in claim 5, wherein the calibration unit generates a first adjustment signal and/or a second adjustment signal based on the differential signal, and the gain control system further comprises:
a first voltage generator, coupled to the calibration unit and the first AGC, receiving a reference voltage and the first adjustment signal to generate the first control voltage; and
a second voltage generator, coupled to the calibration unit and the second AGC, receiving the reference voltage and the second adjustment signal to generate the second control voltage.

8. The gain control system as claimed in claim 7, wherein the calibration unit comprises:
a DSP, generating an adjustment signal;
a DAC, coupled to the DSP, converting the adjustment signal to the first adjustment signal or second adjustment signal which is then sent to a corresponding voltage generator, and in response, the first output voltage or second output voltage is generated as an input signal;
a ADC, coupled to the DSP, converting the input signal to a digital value; wherein:
the DSP recursively generates a plurality of adjustment signals of various levels, and determines a best mode from the corresponding digital values such that error between the first and second output voltages is minimized when operating in best mode.

9. A calibration method for a gain control system comprising a first and a second AGC, comprising:
generating a first and a second control voltages to the first and second AGCs;
amplifying a calibration signal by the first AGC to generate a first output voltage by reference of the first control voltage;
amplifying the calibration signal by the second AGC to generate a second output voltage by reference of the second control voltage;
comparing the first and second output voltages to generate a differential signal; and
adjusting the first control voltage or second control voltage based on the differential signal, such that the amplitudes of the first output voltage and second output voltage are equalized.

10. The calibration method as claimed in claim 9, wherein:
the generation of first and second control voltages is recursively executed, and a plurality of first and second control voltages of various levels are generated for comparison; and
a best mode is selected from the plurality of first and second control voltages, and first and second output voltages are equalized in best mode.
